(19) United States
(12) Patent Application Publication
(10) Pub. No.: US 2024/0009655 A1
(43) Pub. Date: Jan. 11, 2024

(54) METHOD FOR PRODUCING A CATALYST COMPRISING AT LEAST ONE GROUP VIB METAL, AT LEAST ONE GROUP VIIIB METAL AND A CARRIER BASED ON OXIDE(S)

(71) Applicant: IFP Energies nouvelles, Rueil-Malmaison Cedex (FR)

(72) Inventors: Elodie DEVERS, RUEIL-MALMAISON (FR); Pierre-louis CARRETTE, RUEIL-MALMAISON (FR); Philibert LEFLAIVE, RUEIL-MALMAISON (FR); Marine MINIERE, RUEIL-MALMAISON (FR)

(73) Assignee: IFP Energies nouvelles, Rueil-Malmaison Cedex (FR)

(21) Appl. No.: 18/267,371

(22) PCT Filed: Dec. 2, 2021
(86) PCT No.: PCT/EP2021/083875

§ 371 Date: Jun. 14, 2023

(30) Foreign Application Priority Data
Dec. 15, 2020 (FR) 2013245

(51) Int. Cl. B01J 27/19; B01J 37/20; B01J 37/02; B01J 38/04; B01J 38/02; B01J 27/28; B01J 21/04

(52) U.S. Cl. CPC B01J 27/19; B01J 37/20; B01J 37/0203; B01J 38/04; B01J 38/02; B01J 27/285; B01J 21/04

(57) ABSTRACT

The present invention relates to a process for the production of a recycled catalyst comprising at least one metal M1 from group VI B, and/or at least one metal M2 from group VIII, optionally phosphorus and/or sulfur, and a support based on oxide(s). The process comprises the recycling of at least a part of the metal or metals of a source catalyst comprising the metal M1 and/or the metal M2 common with the recycled catalyst to be produced, with:
an extraction by an extraction solution of the metal M1 and/or of the metal M2 from said source catalyst, in order to obtain a solution of extracted metal/metals, then—an impregnation of the support with an impregnation solution resulting from said solution of extracted metal/metals, in order to obtain an impregnated substrate, said extracted metal(s) remaining in the liquid phase from the extraction until the impregnation.

### TECHNICAL FIELD

The present invention relates to the production of catalysts comprising at least one metal from group VIB, at least one metal from group VIIIB and a support based on metal and/or silicon oxides. These catalysts are intended, in particular, to be used in units for the hydrotreating or hydroconversion of hydrocarbons.

### PRIOR ART

The term “hydrotreating” denotes all of the purification processes which make it possible to remove, by the action of hydrogen, the various impurities contained in hydrocarbon feedstocks. Hydrotreating processes make it possible to remove, by the action of hydrogen, impurities present in feedstocks, such as nitrogen (hydrodenitrogenation is then referred to), sulfur (hydrodesulfurization is then referred to), oxygen (hydrodeoxygenation is then referred to) and compounds containing metals which can poison the catalyst and cause operational problems downstream (hydrodemetallization is then referred to). Hydrotreating can thus make it possible to bring the hydrocarbon, the petroleum product, to the required specifications (sulfur content, aromatics content, and the like) for a given application (motor vehicle fuel, gasoline or diesel fuel, domestic fuel oil, and the like). Automotive standards, in particular, have imposed a very strong reduction in the sulfur in diesel and gasoline fuels, hydrotreating thus making it possible to bring these products to the required specifications.

Hydrotreating will thus improve the quality of hydrocarbons, by reducing the content of certain compounds, elements regarded as impurities, but it can also make it possible to reduce the content of aromatic hydrocarbons, by hydrogenation, and to thus improve the cetane number of the hydrocarbons. During hydrotreating processes, small amounts of fuel gas and light cuts, such as LPG (acronym for Liquefied Petroleum Gas) and naphtha, can also be produced.

The hydrocarbon feedstocks targeted by this type of treatment are in particular cuts resulting from coal or hydrocarbons produced from natural gas, optionally as mixtures, or also a hydrocarbon cut resulting from biomass. They can also be heavy synthetic or petroleum cuts, for example kerosenes, gas oils or distillates resulting from atmospheric and vacuum distillation in order to produce kerosene, gas oil or vacuum distillate which can be upgraded, either in the storage unit receiving products of the same type (pool), or to a downstream unit, such as a catalytic cracking unit, where the feedstocks are “cracked” in order to produce hydrocarbons having shorter chains. Frequently, the hydrotreating process is in fact a preliminary stage of treatment of a feedstock by a process of hydroconversion/hydrocracking type.

It is recalled that the hydrocracking (also denoted under the term of hydroconversion) of heavy petroleum cuts is a key process in refining which makes it possible to produce, from surplus and sparingly upgradable heavy feedstocks, lighter fractions, such as gasolines, jet fuels and light gas oils, which the refiner desires in order to adapt its production to demand. Some hydrocracking processes make it possible to also obtain a highly purified residue which can constitute excellent bases for oils.

The feedstocks employed in the hydrotreating process, in a more detailed way, are, for example, gasolines, gas oils, vacuum gas oils, atmospheric residues, vacuum residues, atmospheric distillates, vacuum distillates, heavy fuel oils, oils, waxes and paraffins, spent oils, deasphalted residues or crudes, feedstocks originating from thermal or catalytic conversion processes, lignocellulose feedstocks or, more generally, feedstocks resulting from biomass, such as vegetable oils, taken alone or as a mixture. The feedstocks which are treated, and in particular those mentioned above, generally contain heteroatoms, such as sulfur, oxygen and nitrogen, and, for heavy feedstocks, they usually also contain metals.

Mention may be made, for example, of the patent EP 3 339 401, which describes a hydrotreating and hydroconversion installation, with a common fractionation, for the production of at least one of the following products; naphtha (light and/or heavy), diesel, kerosene, distillate and residue.

Mention may also be made of the patent FR 2 966 835, which describes a process with at least one hydrotreating stage, and which encompasses various alternative forms including a hydrotreating, a hydrocracking, a hydrotreating followed by a hydrocracking without separation between hydrotreating and hydrocracking (also called single-stage hydrocracking), a hydrotreating followed by a hydrocracking with intermediate separation, or a hydrotreating followed by a first hydrocracking, by a separation of the products and by a treatment of the unconverted fraction by another hydrocracking (also called two-stage hydrocracking). This patent recommends, with nitrogenous feedstocks, recycling a part of the hydrotreated or hydrocracked effluent to the hydrotreating or hydrocracking stage after having been subjected to stripping with hydrogen or other inert gas.

Mention may also be made of the patent WO 2015/078675, which describes a hydrotreating of two hydrocarbon fractions each comprising sulfur and nitrogen compounds, using a different or identical catalyst for each of the fractions, and recycling the hydrogen recovered in the two hydrotreated effluents to hydrotreat one of the two fractions.

Conventional hydrotreating catalysts generally comprise an oxide support and an active phase based on metals from groups VIB and VIII in their oxide forms, and also on phosphorus. The preparation of these catalysts generally comprises a stage of impregnation of the metals and the phosphorus on the support, followed by drying and a calcination making it possible to obtain the active phase in their oxide forms. Before their use in a hydrotreating and/or hydrocracking reaction, these catalysts are generally also subjected to a sulfidation.

The addition of an organic additive to the hydrotreating catalysts in order to improve their activity is also known, in particular for catalysts which have been prepared by impregnation followed by drying without subsequent calcination. These catalysts are often referred to as “additive-impregnated dried catalysts”.

The catalysts used in hydrocracking are of bifunctional type, that is to say combining an acid function with a hydrogenating function. The acid function is contributed by supports with high specific surfaces (generally 150 to 800 m²·g⁻¹) exhibiting a high acidity, such as halogenated (in particular chlorinated or fluorinated) aluminas, combinations of boron and aluminum oxides, amorphous silicas-aluminas and zeolites. The hydrogenating function is contributed either by one or more metals from group VIII of the Periodic Table of the Elements, or by a combination of at least one metal from group VIB of the Periodic Table and at least one metal from group VIII, employed in the presence of sulfur. The balance between the two acid and hydrogenating functions governs the activity and the selectivity of the catalyst.

During its operation in a hydrotreating and/or hydrocracking process, the catalyst becomes deactivated by accumulation of coke and/or sulfur-based compounds or compounds containing other heteroelements at the surface of the catalyst. Beyond a certain period, its replacement is thus necessary.

In order to combat these disadvantages, the regeneration (also called gentle calcination) of hydrotreating catalysts is an economically and ecologically advantageous process because it makes it possible to use these catalysts again in industrial units rather than to landfill them or to recycle them (recovery of the metals). The regeneration consists of a heat treatment, generally between 350° C. and 550° C., in the presence of pure or diluted oxygen, the purpose of which is to remove at least a part of the coke present on the spent catalyst by combustion. This regeneration makes it possible for the catalyst called “regenerated” to recover hydrodesulfurizing activity. However, the regenerated catalysts are generally less active than the starting catalysts, also called “fresh”. Consequently, their cycle time in the hydrotreating unit is thus reduced in comparison with that of a fresh catalyst. Optionally, it can be reused in less demanding applications.

In order to overcome the shortfall in hydrodesulfurizing activity of the regenerated catalyst, it is possible to apply an additional treatment called “rejuvenation” treatment. The rejuvenation process consists in reimpregnating the already regenerated catalyst with a solution containing organic or inorganic additives and/or metal precursors. These “rejuvenation” processes are well known, in particular in the field of middle distillates. Although more effective than a simple regeneration, the rejuvenation of the catalysts results, however, in most cases in a catalyst having a lower activity than the fresh catalyst. Finally, some spent catalysts cannot form the subject of reuse via a regeneration or a rejuvenation, either because their integrity is impaired (excessively low size or mechanical strength) or because they contain an excessively large amount of contaminants rendering the performance of the regenerated or rejuvenated product insufficient.

In general, the metals contained in spent hydrotreating or hydroconversion catalysts are not today industrially recycled for the manufacture of new catalysts: they are essentially reused in the manufacture of special alloys, requiring complex purification operations, in particular to rid the recovered metals of compounds regarded as contaminants, such as arsenic, or as problematic in view of the targeted applications, such as phosphorus, the presence of which disturbs, for example, the properties of chromium steel alloys.

Processes have furthermore been developed to recover metals from catalysts, in order to recycle them in the manufacture of new catalysts. This is for example the case of the process described in the patent application US 2007/0167321, which provides for the recovery of molybdenum from spent catalysts in order to make new catalysts. To do this, according to this process, the spent catalyst is dispersed in a basic solution and a contaminant/compound contained in the spent catalyst which it is desired to remove (arsenic, phosphorus) is withdrawn from the solution by causing it to precipitate and by then filtering the solution. The molybdenum is then precipitated by modifying the pH of the solution toward an acidic pH. The molybdenum precipitate is filtered off in order to be able to be reused by dispersion in an impregnation solution furthermore containing precursors of other metals, such as precursors of cesium, antimony or vanadium, and of other components necessary in order to constitute the new catalyst by impregnation of a support.

The patent application EP 2 064 358 provides a fairly similar process, targeted at selectively recovering metals from group VIB from a spent catalyst containing metals from group VIB and metals from group VIII, in order to reuse them for the purpose of manufacturing a new catalyst. The process provided consists in oxidizing the spent catalyst by calcination at 600° C., in physically separating the oxides of the metals from group VIB from the oxides of the metals from group VIII, in then dissolving the oxides of the metals from group VIB in an alkaline solution, in oxidizing the solution with an oxidizing agent of peroxide type, in precipitating the oxides of the metals from group VIB by adding ions of alkaline earth metals, in filtering off the precipitate and in then transforming it into a solid metal compound by addition of acid. It is this solid metal compound which is subsequently dissolved in an impregnation solution also containing compounds of metals from group VIII in order to impregnate supports and to thus produce new catalysts.

These processes are technically advantageous but they are not, however, without drawbacks. This is because they impose a high number of operations, and operations which remain complex for extracting the metals of interest from spent catalysts in order to reuse them in new catalysts, which makes them complicated to implement, and thus not very profitable.

The aim of the invention is consequently to provide new processes for the recycling of metals contained in spent catalysts in order to make new catalysts. It concerns the development of improved processes, which are in particular simpler to implement on the industrial scale, while making possible a high rate of recovery of the metals.

### SUMMARY OF THE INVENTION

A subject matter of the invention is first a process for the production of a recycled catalyst comprising at least one metal M1 from group VIB, and/or at least one metal M2 from group VIII, optionally phosphorus and/or sulfur, and a support based on oxide(s), characterized in that said process comprises the recycling of at least a part of the metal or metals of a source catalyst comprising the metal M1 and/or the metal M2 common with the recycled catalyst to be produced, the process comprising:—an extraction by an extraction solution of the metal M1 and/or of the metal M2 from said source catalyst, in order to obtain a solution of extracted metal/metals, then—an impregnation of the support with an impregnation solution resulting from said solution of extracted metal/metals, in order to obtain an impregnated substrate, said extracted metal(s) remaining in the liquid phase from the extraction until the impregnation.

According to the present invention, it is understood that the impregnation solution “results” from the extraction solution means that there is no intermediate treatment where the extracted metal(s) would be in the solid phase, nor a liquid/liquid extraction treatment of this/these.

To do this, the impregnation solution and the extraction solution preferably have at least one solvent in common.

They can have a solvent or a mixture of solvents which are identical, or varying in the proportion of solvents in the case of a mixture. It can concern, for example, water, or a mixture of solvents comprising predominantly, or essentially, an aqueous solvent.

According to the present invention, “extraction” is understood to mean the fact that there is an extraction stage but that the extraction can be carried out by one extraction operation or a plurality of successive extraction operations.

According to the present invention, “impregnation” is understood to mean the fact that there is an impregnation stage but that the impregnation can be carried out by one impregnation or a plurality of successive impregnation operations.

According to the present invention, “source” catalyst is understood to mean a spent catalyst, that is to say a catalyst which has already been used in production, in particular in installations for hydrotreating or hydroconversion of the hydrocracking type. This catalyst can optionally have already been regenerated, rejuvenated prior to its recycling. This term is also understood to mean a catalyst which has not already been used in production but which is outside specification, for example because it contains an insufficient content of metal/metals, or by a smaller dimensioning than that sought (“fines” of catalyst particles, for example).

According to the present invention, “support” (which will be impregnated with the impregnation solution resulting from the solution of extracted metal/metals) is understood to mean a “new” support of oxides but also a support which has already been impregnated with another impregnation solution (reference is made to preimpregnated support) or a support which is in fact a catalyst (a support provided with metals) but which contains an insufficient amount of metals, such as a spent or regenerated catalyst.

The invention applies advantageously to the recycling of metals from hydrotreating catalysts.

Preferably, the extraction solution and/or the impregnation solution are acidic media.

When these media are aqueous, the acidity of the media is expressed by pH values, in particular of at most 6, for example of between 0.5 and 6. When these media are organic, the acidity can be expressed by a content of mineral or organic acid.

Advantageously, the impregnation solution is devoid of alkali metal elements (column IA of the Periodic Table according to the nomenclature of the Chemical Abstract Service, corresponding to column 1 according to the nomenclature of the IUPAC). This is because it turns out that alkali metals tend to behave as poisons for hydrotreating catalysts.

According to one embodiment, according to the invention, only a single metal M1 or M2 is extracted from the catalyst, in particular when it contains only the metal M1 or only the metal M2. According to another embodiment, the spent catalyst contains both at least one metal M1 and at least one metal M2 and, according to the invention, either only the metal of type M1 or of type M2 is extracted or both the metal of type M1 and of type M2 are extracted.

The invention thus provides a new process, where the metal originating from the source catalyst is dissolved and remains in solution until it is re-employed as impregnation solution makeup for producing the fresh/new catalyst. Unlike the prior techniques, the invention does not seek to recover the metal from the source catalyst in solid and monometallic form, thus sparing itself a number of operations of the precipitation/filtration type. The process of the invention is thus easier to implement on the industrial scale. It is even more simplified thereby when the extraction solution and the impregnation solution have a solvent (or mixture of solvents) in common, in particular when the solvents of the two solutions are identical (or similar, except for the proportion of solvents, for example, in the case of a mixture of solvents).

Preferably, the extraction is carried out with a solution comprising a solvent, in particular an aqueous solvent, and at least one organic compound having complexing properties, and optionally also acidic properties.

This is because it turns out that adding an organic compound to the (generally aqueous) solution was very effective in extracting the metals of interest which it is desired to recycle, by passing them into the liquid phase, while the support of the source catalyst and optional other components of the spent catalyst remain in the solid phase and are thus easily removable.

It should be emphasized that the organic compounds which give the most advantageous results are compounds having acidic and complexing properties. This is because an organic acid makes it possible to protonate the metal oxide, thus limiting its interaction with the support and promoting its dissolution in the extraction solution. A complexing agent for its part makes it possible to form a metal complex which is soluble in the extraction solution. The combination of the acidic and complexing properties is thus particularly advantageous. The use of an organic compound having these two properties or the combination of an acidic organic compound and of a complexing organic compound is thus particularly indicated.

This organic compound, or at least one of them when there are several of them, can comprise one or more chemical functions chosen from a carboxylic acid, phosphoric acid, sulfonic acid, alcohol, thiol, thioether, sulfone, sulfoxide, ether, aldehyde, ketone, ester, carbonate, amine, nitrile, imide, oxime, urea and amide function, or also compounds including a furan ring or also sugars.

The organic compound (or at least one of them when there are several of them) can be chosen from one at least of the following compounds: formic acid, acetic acid, oxalic acid, malonic acid, glutaric acid, glycolic acid, lactic acid, tartronic acid, citric acid, tartaric acid, pyruvic acid, γ-ketovaleric acid, succinic acid, acetoacetic acid, gluconic acid, ascorbic acid, phthalic acid, salicylic acid, maleic acid, malic acid, fumaric acid, acrylic acid, thioglycolic acid, 2-hydroxy-4-methylthiobutanoic acid, glutamic acid, N-acetylglutamic acid, alanine, glycine, cysteine, histidine, aspartic acid, N-acetylaspartic acid, 4-aminobutanoic acid, 1,2-cyclohexanediaminetetraacetic acid, ethylenediaminetetraacetic acid (EDTA), nitrilotriacetic acid (NTA), iminodiacetic acid (IDA), N-(2-hydroxyethyl)ethylenediamine-N,N′,N′-triacetic acid (HEDTA), diethylenetriaminepentaacetic acid (DTPA), bicine, tricine, 1-hydroxyethylidene-1,1-diphosphonic acid (HEDP or etidronic acid), nitrilotris(methylenephosphonic acid), diethylenetriaminepentakis(methylenephosphonic acid), 4-sulfophthalic acid, 3-(N-morpholino)-2-hydroxy-1-propanesulfonic acid (MOPSO), 2-(4-pyridinyl)ethanesulfonic acid, phenol-4-sulfonic acid, thiodiacetic acid and diglycolic acid.

This is because the chemical compounds of this group exhibit both acidic and complexing properties.

The organic compound (or at least one of them) can be chosen from one at least of the following compounds: dimethylglyoxime, methyl acetoacetate, ethyl acetoacetate, ethyl lactate, methyl glycolate, ethyl glycolate, dimethyl malate, diethyl malate, dimethyl tartrate, diethyl tartrate, ethyl 3-hydroxybutanoate, ethyl 3-ethoxypropanoate, methyl 3-methoxypropanoate, methyl 3-(methylthio)propanoate, ethyl 3-(methylthio)propanoate, ethylene glycol, diethylene glycol, triethylene glycol, a polyethylene glycol (with a molecular weight of between 200 and 1500 g/mol), propylene glycol, glycerol, 2-butoxyethanol, 2-(2-butoxyethoxy)ethanol, 2-(2-methoxyethoxy)ethanol, triethylene glycol dimethyl ether, a crown ether, acetophenone, 2,4-pentanedione, pentanone, glucose, fructose, sucrose, sorbitol, xylitol, mannitol, γ-valerolactone, propylene carbonate, octylamine, N,N-diethylformamide, N,N-dimethylformamide, N-methylformamide, N,N-dimethylacetamide, propanamide, 1-methyl-2-pyrrolidinone, tetramethylurea, N,N′-dimethylurea, acetonitrile, lactamide, furfurol, 2-furaldehyde, 5-hydroxymethylfurfural, ethyl 3-hydroxybutanoate, 2-hydroxyethyl acrylate, 1-vinyl-2-pyrrolidinone, N,N,N′,N′-tetramethyltartramide, 3-hydroxypropionitrile and N,N′-bis(2-hydroxyethyl)ethylenediamine.

This is because the chemical compounds of this group exhibit complexing properties.

Advantageously, the extraction solution also comprises at least one mineral acid, in particular phosphoric acid, nitric acid or boric acid. This combination between a complexing organic compound and a mineral acid has proven to be very effective, making possible all at once good extraction of the targeted metals, by creating, in particular, a favorable sufficiently acidic environment, all the more so when the impregnation of the support using this solution has to be carried out in an acidic medium, a fortiori when the final catalyst has to contain phosphorus, when it is phosphoric acid which is chosen.

The concentration of each organic compound of the extraction solution is defined so that the concentration of organic compound(s) of the extraction solution is defined so that the organic compound/extracted metal(s) molar ratio, for the organic compound or for each of the organic compound(s) when there are several of them, is of between 0.2 and 25, preferably between 0.2 and 11, preferably between 0.2 and 5, preferably between 0.4 and 2 and in a preferred way between 0.4 and 1.2.

Advantageously, the recycling according to the invention can comprise at least one stage of treatment of the source catalyst, prior to the extraction by the liquid route, chosen from one at least of the following treatments: decoking, separation of compounds of contaminants/impurities type, mechanical grinding. The aim of these preliminary treatments is to make the extraction more efficient, by mechanical, physical or chemical treatments: grinding reduces the particle size of the particles of the source catalyst and increases the particles/extraction solution contact surface area. Removing or reducing the amount of coke and other contaminants proceeds in the same direction, by improving/increasing the contact between the extraction solution and the metals to be extracted contained in the source catalyst.

Advantageously, the recycling can comprise at least one stage of treatment of the solution of extracted metal/metals before impregnation, chosen from at least one of the following treatments: concentration, dilution, modification of the composition of the solution by complete or partial addition or removal of at least one compound. According to one embodiment, this or these treatment stage(s) are only chosen from a concentration, a dilution, a modification of the composition of the solution by complete or partial addition or removal of at least one compound.

The purpose of these post-treatments is to place the extraction solution under the conditions desired to serve as impregnation solution. A concentration, by thus withdrawing at least a part of the solvent/of the non-metallic compounds from the solution, will make it more efficient and bring it closer to the concentrations required for carrying out an impregnation in conventional processes for the impregnation of fresh catalyst. It is the same, for example, by contributing, to this solution, constituent elements of the catalyst to be produced, in particular contributing at least one metal not present in the solution, or present in an insufficient amount.

The impregnation of the support can thus be carried out starting from the solution of extracted metal/metals and from a makeup of at least one of the metals M1, M2, and optionally also from a makeup of phosphorus and optionally also from a makeup of organic additive(s). This is because the addition of an organic additive to the hydrotreating catalysts has been recommended by a person skilled in the art in order to improve their activity. The makeup can either be added beforehand to the solution of extracted metal/metals for a premix, or be added separately from the solution of extracted metal/metals to the device where the impregnation of the supports is carried out. The makeup can be carried out in liquid or nonliquid form; it will rather be in liquid form if it is added separately and can be in liquid or solid form if it is added to the solution of extracted metal(s) prior to the impregnation proper.

Optionally, the process according to the invention can also comprise a stage of sulfidation of the impregnated substrate: when the catalyst to be produced must contain sulfur, it is known to introduce the sulfur, in all or in part, right at the end of the production process, either ex situ on the line for production of the catalyst or in situ on the hydrotreating installation in the hydrotreating reactor, in particular during the phase of start-up of the installation.

The process according to the invention can also comprise one or more stages of heat treatment of the support once impregnated. It generally comprises at least one heat treatment of the drying type. It can also comprise a calcination.

In a way known in the manufacture of new catalysts, there is generally provided, after the impregnation:
an optional maturation stage,
a drying or a calcination,
the optional addition of an organic additive,
and, in the case of the addition of organic additive, again a drying,
and, finally, an optional sulfidation.

These stages, and in particular the postimpregnation of an organic additive, can thus be carried out in a similar way for the recycled catalyst of the present invention.

According to the invention, it is possible to reuse a part at least of the impregnation solution after impregnation of the support, in particular as makeup for the extraction solution. This thus limits the consumption of the process in solvent and in (optional) organic compound.

According to the invention, the solution of extracted metal/metals can be concentrated in order to withdraw therefrom a part at least of the solvent and optionally a part at least of the optional organic compound which it contains, and then at least a part of the solvent/of the organic compound thus withdrawn is reused as makeup for the extraction solution. Here again, this reuse makes it possible to limit the consumption of the process in solvent/organic compound.

According to one embodiment, the process according to the invention comprises the following (successive but not necessarily consecutive) stages:
at least one stage (a1, a2, a3) of treatment of the source catalyst,
the extraction (b) with an extraction solution of the metal or metals of said source catalyst, in order to obtain a solution of extracted metal/metals,
at least one optional stage (c) of purification of the solution of extracted metal/metals produced in stage (b) in order to withdraw therefrom all or some of possible impurities,
at least one optional stage (d) of concentration of the solution of extracted metal/metals,
at least one optional stage (e) of adjustment of the composition of the solution of extracted metal/metals resulting from stage (b), (c) or (d),
the impregnation (f) by the liquid route of the support with an impregnation solution resulting from said solution of extracted metal/metals obtained in stage (b), (c), (d) or (e), with an optional makeup of metal/metals, of phosphorus and of organic additive(s), in order to obtain an impregnated substrate, said extracted metal or metals remaining in the liquid phase from the extraction as far as the impregnation (according to whether stages (c), (d) and (e) are or are not carried out and according to the order in which they are carried out),
optional sulfidation (g) of the impregnated support obtained in stage (f).

It should be noted that stage (b) is carried out before stage (f) and that the sulfidation (g) is carried out after stage (f). The optional stages (c), (d) and (e) are preferably carried out in the order of the statement of the stages indicated above, that is to say stage (c), then (d) and then (e), but they can also be carried out in a different order (such as (d), (c), (e) or (c), (e), (d) or (e), (c), (d)).

As mentioned above, the process according to the invention is targeted at producing more particularly a hydrotreating or hydrocracking catalyst.

The spent catalyst used in the recycling process according to the invention can, beforehand, be regenerated or rejuvenated, before recycling by liquid extraction of the metals.

The metal M1 of the catalyst to be produced is preferably Mo and/or W and the metal M2 of said catalyst is preferably Ni and/or Co. Its support is preferably based on silicon and/or aluminum oxide and it preferably contains phosphorus and optionally sulfur. The source catalyst is of the same type and contains at least the same metal M1 and/or the same metal M2 as the catalyst to be produced.

In the process according to the invention, provision may be made for the support on which the impregnation is carried out with the impregnation solution resulting from the solution of extracted metal/metals to be preimpregnated with a (conventional) impregnation solution. After impregnation with the impregnation solution according to the invention, the support can also be postimpregnated with a conventional impregnation solution. The term “conventional” impregnation solution is understood to mean a “fresh” solution containing, in known way, precursors of the components of the active phase of the catalyst, very particularly metal components. The aim of this preimpregnation and/or postimpregnation of the support is in particular to adjust, if necessary, the amount of metals in order for the catalyst ultimately to have the desired composition.

The support can also, within the meaning of the invention, be a catalyst depleted in metal of the optionally regenerated/rejuvenated spent catalyst type.

The invention also relates to the catalyst produced according to the process described above, which can thus comprise entirely one or more recycled metals, or partly one or more recycled metals and “fresh” metals.

It also relates to any hydrotreating or hydrocracking catalyst, which comprises a mixture of particles of fresh catalyst (which is obtained without the recycling according to the invention) and particles of catalyst which is obtained with the recycling process of the invention.

### LIST OF THE FIGURES

FIG. 1 represents a block diagram of a first alternative form of the installation implementing the process according to the invention.

FIG. 2 represents a block diagram of a second alternative form of the installation implementing the process according to the invention.

The figures are highly diagrammatic and do not necessarily represent all the operations which may be involved in the process according to the invention. The references which are identical from one figure to the other relate to the same operation/to the same component/to the same device.

### DESCRIPTION OF THE EMBODIMENTS

### Definitions

The groups of chemical elements are given according to the CAS classification (CRC Handbook of Chemistry and Physics, published by CRC Press, Editor in Chief D. R. Lide, 81st edition, 2000-2001). For example, group VIII according to the CAS classification corresponds to the metals of columns 8, 9 and 10 according to the new IUPAC classification.

The Source Catalyst

In the nonlimiting examples and in the detailed description of the invention, it is considered that the specifications, the formulation of the catalyst to be produced by recycling corresponds to that of the “source” catalyst (minus its contaminants, coke, and the like, which will gradually deactivate it).

Naturally, it remains within the scope of the present invention to produce a recycled catalyst from a source catalyst which contains:
at least one metal common with it but possibly not all the metals common with it,
and/or one or more common metals but in different contents,
or even one or more common metals and one or more additional metals which will not form part of the composition of the recycled catalyst produced.

Thus, it is possible to use a source catalyst which does not have the same function as the recycled catalyst to be produced, as long as they have at least one metal in common (hydrotreating catalyst, hydrocracking catalyst, Fischer-Tropsch catalyst), or which has the same function (hydrotreating catalyst in both cases, for example).

This is because it was seen above that the process according to the invention makes it possible, by an optional adjustment stage, to adjust the composition of the catalyst produced, and the extraction stage according to the invention can be chosen to be selective, that is to say operated so as to extract from the source catalyst only the metal or metals common with the catalyst to be produced.

The specifications are as follows:

The source catalyst of the process according to the invention is a catalyst comprising at least one oxide support and at least one metal, preferentially several metals. The term “source” according to the invention has been defined above.

The source catalyst comprises at least one metal belonging to group VIII and/or at least one metal belonging to group VIB, an oxide support and optionally phosphorus. It can also, without limitation, comprise coke and/or sulfur as described below.

The discharging of the spent catalyst from a hydrotreating and/or hydrocracking process is preferably preceded by a deoiling stage. The deoiling stage generally comprises bringing the at least partially spent catalyst into contact with a stream of inert gas (that is to say essentially devoid of oxygen), for example in a nitrogen atmosphere or the like, at a temperature of between 300° C. and 400° C., preferably of between 300° C. and 350° C. The inert gas flow rate in terms of flow rate per unit volume of the catalyst is from 5 to 150 Sl·h⁻¹ for 3 to 7 hours. In an alternative form, the deoiling stage can be carried out by light hydrocarbons, by steam treatment or any other analogous process.

The oxide support of said source catalyst of the process according to the invention is usually a porous solid chosen from the group consisting of: aluminas, silica, silica-aluminas and also titanium or magnesium oxides, used alone or as a mixture with alumina or silica-alumina.

In another preferred case, the oxide present in the support of said source catalyst of the process according to the invention is a silica-alumina containing at least 50% by weight of alumina, with respect to the total weight of the composite support. The silica content in the support is at most 50% by weight, with respect to the total weight of the support, generally less than or equal to 45% by weight, preferably less than or equal to 40% by weight.

According to a particularly preferred alternative form, the support of the source catalyst consists of alumina, silica or silica-alumina.

The oxide support can also advantageously additionally contain from 0.1% to 80% by weight, preferably from 0.1% to 50% by weight, of zeolite, with respect to the total weight of the support. In this case, all sources of zeolite and all associated preparation methods which are known can be incorporated. Preferably, the zeolite is chosen from the group FAU, BEA, ISV, IWR, IWW, MEI, UWY and preferably the zeolite is chosen from the group FAU and BEA, such as zeolite Y and/or beta zeolite, and particularly preferably such as USY and/or beta zeolite.

The support is advantageously provided in the form of beads, extrudates, pellets or irregular and nonspherical agglomerates, the specific shape of which can result from a crushing stage.

The active phase of the source catalyst preferably comprises at least one metal from group VIB and at least one metal from group VIII. The metal from group VIB present in the active phase of the catalyst is preferentially chosen from molybdenum and tungsten, or the mixture of these two elements. The metal from group VIII present in the active phase of the catalyst is preferentially chosen from cobalt, nickel and the mixture of these two elements. The active phase of the catalyst is preferably chosen from the group formed by the combination of the elements nickel-molybdenum, cobalt-molybdenum, nickel-cobalt-molybdenum, nickel-tungsten, nickel-molybdenum-tungsten and nickel-cobalt-tungsten.

The content of metal from group VIII is of between 1% and 10% by weight of oxide of the metal from group VIII, with respect to the total weight of the dry catalyst, preferably of between 1.5% and 9% by weight and preferably of between 2% and 8% by weight. When the metal is cobalt or nickel, the metal content is expressed as CoO and NiO respectively.

The content of metal from group VIB is of between 5% and 40% by weight of oxide of the metal from group VIB, with respect to the total weight of the dry catalyst, preferably of between 8% and 35% by weight, very preferably of between 10% and 30% by weight. When the metal is molybdenum or tungsten, the content of metal is expressed as MoO₃ and WO₃ respectively.

The metal from group VIII to metal from group VIB molar ratio in the catalyst, when the latter contains both types of metals, is preferentially of between 0.1 and 0.8, preferably of between and 0.6 and more preferably still of between 0.2 and 0.6 or also between 0.3 and 0.5.

The source catalyst of the process according to the invention can also comprise phosphorus as dopant. The dopant is an added element which, in itself, does not exhibit any catalytic nature but which increases the catalytic activity of the active phase.

The phosphorus content in said source catalyst is then preferably of between 0.1% and 20% by weight, expressed as P₂O₅ with respect to the total weight of the dry catalyst, preferably between 0.2% and 15% by weight, expressed as P₂O₅, and very preferably between 0.3% and 8% by weight, expressed as P₂O₅.

The phosphorus to the element from group VIB molar ratio in the catalyst is greater than or equal to 0.05, preferably greater than or equal to 0.07, preferably of between 0.08 and 1, preferably of between 0.01 and 0.9 and very preferably of between 0.15 and 0.6.

The source catalyst of the process according to the invention can comprise sulfur. The sulfur content in said source catalyst is then preferably of between 1% and 15% by weight, expressed as element with respect to the total weight of the dry catalyst, preferably between 2% and 12% by weight and very preferably between 4% and 10% by weight. The sulfur content is measured by elemental analysis according to ASTM D5373.

The source catalyst of the process according to the invention can comprise coke, in particular when it has not been regenerated. It should be noted that the term “coke” in the present patent application denotes a substance based on hydrocarbons which is deposited on the surface of the catalyst during its use, which is highly cyclized and condensed and which has an appearance similar to graphite.

The coke content, expressed as % by weight of the carbon element, can be of between 5% and 20% by weight, preferably between 6% and 16% by weight and in particular between 7% and 14% by weight, with respect to the total weight of the dry catalyst. The coke content is determined according to the ASTM D5373 method.

Optionally, the source catalyst can additionally exhibit a low content of contaminants resulting from the feedstock treated by the fresh catalyst from which it originates, such as silicon, arsenic, iron, sodium or chlorine, or also sulfur.

Preferably, the silicon content of the source catalyst (besides that possibly present on the fresh catalyst) is less than 2% by weight and very preferably less than 2000 ppm by weight, with respect to the total weight of the source catalyst.

Preferably, the arsenic content is less than 2000 ppm by weight and very preferably less than 500 ppm by weight, with respect to the total weight of the source catalyst.

Preferably, the chlorine content is less than 2000 ppm by weight and very preferably less than 500 ppm by weight, with respect to the total weight of the regenerated catalyst.

Preferably, the sulfur content is less than 2% by weight and very preferably less than 2000 ppm by weight, with respect to the total weight of the source catalyst.

Very preferably, the source catalyst, when it is a regenerated catalyst, is not contaminated, that is to say contains a content of less than 100 ppm by weight of silicon (besides that possibly present on the fresh catalyst), 100 ppm by weight of sodium (besides that possibly present on the fresh catalyst), 50 ppm by weight of arsenic, 50 ppm by weight of iron and 50 ppm by weight of chlorine.

According to one embodiment of the invention, the source catalyst of the process according to the invention can comprise or consist of fines produced during the operation of discharging the spent catalyst from the industrial unit from which it is withdrawn, or during the regeneration.

According to another embodiment, the source catalyst of the process according to the invention comprises or consists of fines and/or of products outside the specifications resulting from the various unit operations of the manufacture of new catalysts.

The Stages of the Process for the Manufacture of a Catalyst Based on Recycled Metals According to the Invention

Stage (a) (Optional): Stage(s) Preliminary to the Extraction

When the source catalyst is a spent catalyst, the latter is produced during the process for the hydrotreating, in particular the hydrodesulfurization or the hydroconversion, of a hydrocarbon cut containing sulfur and also other contaminants, such as silicon, arsenic, chlorine, iron, sodium or nitrogen. The formation of coke and/or the deposits of contaminants transform the fresh catalyst into an at least partially spent catalyst.

The optional stage (a) consists in withdrawing all or part of one or more of the impurities possibly contained in said source catalyst before stage (b) of extraction of the metals, by any method known to a person skilled in the art. Preferably, stage (a) comprises a regeneration stage in order to remove all or part of the coke, of the sulfur and/or of the chlorine, as described in detail below, or a stage of heat treatment under a gas stream containing hydrogen sulfide, carried out in particular in order to remove the arsenic.

Example of Stage (a1): Regeneration

The at least partially spent catalyst is subjected to a stage of removal of the coke and of the sulfur: a regeneration stage, which makes it possible to remove all or part of the coke, of the sulfur and/or of the chlorine possibly deposited on the catalyst.

Even if this is possible, the regeneration is preferably not carried out by keeping the laden catalyst in the hydrotreating reactor (in situ regeneration). Preferably, the at least partially spent catalyst is thus extracted from the reactor and sent to a regeneration plant in order to carry out the regeneration in said plant (ex situ regeneration).

The regeneration stage is generally carried out in a gas stream containing oxygen, generally air. The water content in the gas is generally of between 0% and 50% by weight. The gas flow rate in terms of flow rate per unit volume of the at least partially spent catalyst is preferably from 20 to 2000 Sl·h⁻¹, more preferably from 30 to 1000 Sl·h⁻¹ and particularly preferably from to 500 Sl·h⁻¹. The duration of the regeneration is preferably 2 hours or more, more preferably 2.5 hours or more and particularly preferably 3 hours or more. The regeneration of the at least partially spent catalyst is generally carried out at a temperature of between 320° C. and 550° C., preferably of between 360° C. and 500° C.

The regenerated source catalyst is composed of the oxide support and of the active phase formed of at least one metal from group VIB and of at least one metal from group VIII and optionally of phosphorus from the source catalyst. The regenerated catalyst is characterized by a specific surface of between 20 and 300 m²/g, preferably of between 30 and 280 m²/g, preferably of between 40 and 260 m²/g, very preferably of between 80 and 250 m²/g.

The pore volume of the source catalyst (spent then regenerated here) is generally of between 0.1 cm³/g and 1.3 cm³/g, preferably of between 0.2 cm³/g and 1.1 cm³/g.

The regenerated catalyst obtained in the regeneration stage contains residual carbon at a content of less than 3% by weight, with respect to the total weight of the regenerated catalyst, preferably of between 0% and 2.9% by weight, with respect to the total weight of the regenerated catalyst, preferentially of between 0% and 2.0% by weight and particularly preferably between 0% and 1.0% by weight. It should be noted that the term “residual carbon” in the present patent application means carbon (coke) remaining in the regenerated catalyst after regeneration of the spent hydrotreating catalyst. This residual carbon content in the regenerated hydrotreating catalyst is measured according to the ASTM D5373 method.

Example of Stage (a2): Heat Treatment Under a Gas Stream Containing Hydrogen Sulfide (Process Optionally Cumulative with the Regeneration of the Preceding Stage (a1))

All or part of the elemental arsenic or of the arsenic compounds potentially contained in the source catalyst can be removed by passing a stream of hydrogen sulfide and of steam or of inert gas through the solid at a temperature of between 300° C. and 750° C. During this treatment, the arsenic contained in the source catalyst forms arsenic sulfide (of formula As₂S₃) which is volatilized from the solid. The reaction is preferably carried out by fluidizing the solid in the stream of hydrogen sulfide and of steam or of inert gas. When a mixture of hydrogen sulfide and of inert gas is used, the latter is preferentially nitrogen, carbon dioxide or combustion gases.

### Example of Stage (a3): Optional Preliminary Grinding

The source catalyst can advantageously undergo, before the extraction, an optional grinding stage in order to promote the kinetics of extraction of the metals during the extraction stage (b) of the process according to the invention. In this case, the stage comprises a first optional phase of conditioning of the source catalyst (a3) with at least one grinding so as to obtain particles of source catalyst having a size of at most 1 mm. It is of course possible to carry out several successive grinding stages in order to reach the targeted particle size. Any method known to a person skilled in the art can be employed to carry out this crushing or grinding stage, such as, for example, the use of a ball mill or a rotary cutter mill. Preferentially, the size of the source catalyst used during the extraction stage (b) according to the invention is of between 1 and 1000 micrometers (1 mm), preferably of between 80 and 500 micrometers and in a preferred way of between 100 and 400 micrometers. Most often, the ground source catalyst is conveyed into the extraction zone by any means known to a person skilled in the art, in particular by a screw conveyor or by pneumatic transfer.

Extraction Stage (b)

According to this stage, the source catalyst is brought into contact with an extraction solution containing at least one organic compound preferably having complexing and optionally acidic properties (either at least one compound having both properties, or the combination of at least one acidic compound and of at least one complexing compound, or only at least one complexing compound, for example).

The extraction solution according to the present invention can comprise any polar protic solvent known to a person skilled in the art. Preferably, a polar protic solvent, for example chosen from the group formed by methanol, ethanol and water, or also a water-ethanol or water-methanol mixture, is used. Very preferably, the solvent used in the impregnation solution consists of water. In the case of an aqueous solution, the pH of said solution will be able to be modified by the optional addition of an acid or of a base. The extraction solution has a pH generally of between 0.1 and 8.5, in a preferred way of between 0.5 and 6, preferably of between 1 and 4.

Generally, the organic compound is chosen from a compound comprising one or more chemical functions chosen from a carboxylic acid, phosphonic acid, sulfonic acid, alcohol, thiol, thioether, sulfone, sulfoxide, ether, aldehyde, ketone, ester, carbonate, amine, nitrile, imide, oxime, urea and amide function or also compounds including a furan ring or also sugars.

Examples of complexing organic compounds, and both complexing and acidic organic compounds, have already been listed above; the lists will thus not be repeated here.

The concentration of each organic compound in the extraction solution is defined so that the organic compound/extracted metals molar ratio is of between 0.2 and 25, preferably between and 11, preferably between 0.2 and 5, preferably between 0.4 and 2 and in a preferred way between 0.4 and 1.2.

When several organic compounds are present, the various molar ratios apply for each of the organic compounds present.

In one embodiment according to the invention, the extraction solution can also contain phosphorus. The presence of phosphorus in the extraction solution promotes the extraction of the metals and in particular of molybdenum, by virtue of the high stability of the heteropolyanions which this metal forms with phosphorus. The addition of phosphorus in the form of phosphoric acid H₃PO₄ also makes it possible to lower the pH of the solution, which is also generally beneficial for the extraction of the metals contained in the source catalyst. It is also possible to use mineral acids other than phosphoric acid, in particular nitric acid or boric acid.

The preferred phosphorus precursor is phosphoric acid H₃PO₄ but its esters and its salts, such as ammonium phosphates, are also suitable, just like polyphosphates. Without being committed to any theory, it seems that the combination of phosphoric acid with an organic acid having an acidity constant pKa of greater than 1.5, that is to say a weak organic acid, makes it possible to observe a synergistic effect at the level of the extraction of the metals which is not foreseeable when phosphoric acid or the organic acid is used alone. The extraction in the presence of two specific acids makes possible very good dissolution of the metal phases.

In one embodiment according to the invention, the extraction solution can also contain an oxidizing agent for promoting the extraction of the metals. Preferably, the oxidizing agent contained in the extraction solution is hydrogen peroxide. When an oxidizing agent is present, the concentration is generally of between 0.1 and 5.0 mol·l⁻¹.

In general, the operating conditions of stage (b) are chosen so as to maximize the extraction of the metals contained in the source catalyst, while minimizing the dissolution of the metal(s) contained in the support of said source catalyst and while limiting the amount of organic compound in order for the latter not to be in too great excess with respect to the optimum amount of organic compound necessary in the impregnation stage in order to obtain high-performance catalysts. It is also sought to minimize the amount of extraction solution to be used, in order to obtain a metal solution which is as concentrated as possible at the end of the extraction: the need to concentrate the solution before using it in the impregnation solution or as impregnation solution is thus limited.

The contacting operation is carried out with the extraction solution under the following conditions:
temperature: between 10 and 150° C., in particular between 15 and 95° C.,
pressure: between atmospheric pressure and 20 bar, in particular at atmospheric pressure or at most 10 bar,
duration: between 1 minute and 20 hours, preferably between 5 and 300 minutes, in a preferred way between 5 and 180 minutes.

Preferably, the device(s) in which the contacting operation is carried out do not have items of heating equipment, and the temperature of the contacting operation is regulated by the temperature of the extraction solution. The temperature of the extraction solution can be of between 15° C., 20° C. or 25° C. and 95° C. and preferentially between 30° C. and 90° C., and more preferably still between 50° C. and 85° C. It can thus be at ambient temperature, or have been heated, for this specific contacting stage. It can also be at a given temperature, in particular above ambient temperature, because it originates, at least in part, from the recycling of liquid effluents produced in the process according to the invention and which are already in this temperature range.

The amount of extraction solution used for this stage is preferably as low as possible in order to obtain the desired effect, as indicated above. Preferably, this stage (b) is carried out by bringing the source catalyst into contact with a volume of said solution of between 1.5 and 60 times the volume of the source catalyst. Preferably, the volume of said solution is of between 2 and 30 times the volume of the source catalyst and more preferentially between 2 and 20 times the volume of the source catalyst.

All the modes of bringing into contact in a single stage or in several stages according to a cocurrent, countercurrent or crosscurrent mode are possible for the implementation of stage (b) in continuous mode. A batch contacting operation can also be provided. By way of illustration, the contacting operation can be carried out by dipping, or else under flow of the extraction solution, for example by distribution of the trickling extraction solution over the source catalyst, which is optionally placed in motion.

At the end of stage (b), the solution is separated from the solid residue in order to obtain, on the one hand, a leached catalyst and, on the other hand, the metal solution which will be used in the following stages (c), (d), (e) or (f). Preferably, the residual metal content of the leached catalyst (sum of the contents of the different metals contained in the leached catalyst, expressed as oxide) is less than 10% by weight, preferentially less than 5% by weight and very preferably less than 2% by weight. Any method of liquid/solid separation can be used, such as, for example, by filtration or by draining, for example by gravity. Preferably, the separation stage is carried out with a device of filter press type.

Stage (c) (Optional): Purification

The optional stage (c) of purification of the metal solution produced in stage (b) has the role of withdrawing all or part of the impurities possibly contained in the metal solution, resulting in particular from the impurities potentially present on the source catalyst or linked to a partial dissolution of the support of said catalyst. Stage (c) can take place in a single stage or in several successive stages.

In the case where the metal solution contains suspended solids after the separation stage, at the end of stage (b), any known method for removing these suspended solids can be used during this stage (c). Preferably, this removal is carried out by filtration (for example, microfiltration and ultrafiltration on crossflow filter). Other methods are centrifugation or coagulation.

For the dissolved impurities, such as, for example, arsenates or arsenites, all the known methods can be used during this stage (c), in particular and preferably, sorption on solid, precipitation and extraction by solvent, care being taken not to remove, at the same time, the metals of interest which have been extracted.

Stage (d) (Optional): Concentration

Stage (d) consists in concentrating the metal solution resulting from stage (b) or (c) by removal of a part of the solvent, and of all or part of the organic compound contained in the metal solution. This stage may be necessary if the metal concentrations are too low with respect to the concentrations necessary to carry out an impregnation. Any known method for withdrawing a portion of a solvent from a solution is envisaged. Stage (d) can take place in a single stage or in several successive stages. All or part of the solvent, containing or not containing organic compound, extracted from the metal solution in this stage (d) can be recycled to the extraction stage (b).

Preferably, and in particular in the case where the metal solution is an aqueous solution, stage (d) is carried out by evapoconcentration. In this case, a neutralization will preferentially be carried out, so that the effluent enters the evaporator in a pH range from 5 to 7. This regulation of the pH makes it possible to limit the phenomena of codistillation, unless the latter is sought for the coremoval of the solvent and of a part of the organic compound and, moreover, in order to avoid as much as possible the precipitation of metal oxides. Preferably, all or part of the distillate is recycled to the extraction stage (b).

When only the removal of a part of the solvent is desired, besides evapoconcentration, the preferred techniques are membrane techniques and very preferably nanofiltration, reverse osmosis and pervaporation, solvent extraction or also cryoconcentration.

When it is desired to remove solvent and organic compound(s) when they are used, a preferred technique is evapoconcentration.

Stage (e) of Adjustment of the Composition of the Metal Solution (Optional)

Stage (e) consists in modifying the metal solution resulting from stage (b), (c) or (d) by addition(s) and/or removal(s) of certain constituents. Metal precursors and/or phosphorus precursors and/or organic additives can be added. Organic compounds used for the extraction of the metals can also be withdrawn, in all or part, if necessary. The objective is to obtain a metal solution, the composition of which corresponds to that desired for the impregnation solution used for the synthesis of the catalyst according to the invention in the impregnation stage (f).

Case of the Metals:

Even if it is desired for the catalyst according to the invention to have a formulation identical to that of the source catalyst, the ratios between metals of the metal solution are potentially to be adjusted, on the one hand because the purification—stage (a)—of the catalyst can modify the initial contents of metals of the source catalyst and, on the other hand, because the extraction stage (b) can bring about different extraction rates for each of the metals.

The adjustment of the ratios between metals is carried out either by addition of a makeup solution containing one or more of said metals, or by direct dissolution of one or more metal precursors in the metal solution resulting from stage (b), (c) or (d), the latter alternative being preferred. The metal from group VIII to metal from group VIB molar ratio in the metal solution resulting from stage (e), already specified above, is generally of between 0.1 and 0.8, preferably of between 0.15 and 0.6.

Use may be made, by way of example for the metal precursors, among the sources of molybdenum, of the oxides and hydroxides, molybdic acids and their salts, in particular the ammonium salts, such as ammonium molybdate or ammonium heptamolybdate, phosphomolybdic acid (H₃PMo₁₂O₄₀) and their salts, and optionally silicomolybdic acid (H₄SiMo₁₂O₄₀) and its salts. The sources of molybdenum can also be any heteropolycompound of Keggin, lacunary Keggin, substituted Keggin, Dawson, Anderson or Strandberg type, for example. Use is preferably made of molybdenum trioxide and the heteropolycompounds of Keggin, lacunary Keggin, substituted Keggin and Strandberg type.

The tungsten precursors which can be used are also well known to a person skilled in the art. For example, use may be made, among the sources of tungsten, of the oxides and hydroxides, tungstic acids and their salts, in particular the ammonium salts, such as ammonium tungstate or ammonium metatungstate, phosphotungstic acid and their salts, and optionally silicotungstic acid (H₄SiW₁₂O₄₀) and its salts. The sources of tungsten can also be any heteropolycompound of Keggin, lacunary Keggin, substituted Keggin or Dawson type, for example. Use is preferably made of the oxides and the ammonium salts, such as ammonium metatungstate, or the heteropolyanions of Keggin, lacunary Keggin or substituted Keggin type.

The cobalt precursors which can be used are advantageously chosen from the oxides, hydroxides, hydroxycarbonates, carbonates and nitrates, for example. Use is preferably made of cobalt hydroxide and cobalt carbonate. Cobalt acetoacetate may also be concerned.

The nickel precursors which can be used are advantageously chosen from the oxides, hydroxides, hydroxycarbonates, carbonates and nitrates, for example. Nickel acetoacetate may also be concerned.

Case of the Phosphorus:

A phosphorus precursor can be used for the extraction stage (b). If the phosphorus/metal ratio of the metal solution resulting from stage (b), (c) or (d) is lower than that desired for the impregnation solution of stage (f), a phosphorus precursor, identical to or different from that optionally used in stage (b), can be added to the metal solution during stage (e). This will in particular be the case when no phosphorus compound/precursor was added in stage (b) or when it was consumed, at least in part, by the support, when it contains alumina, to form aluminophosphates. In this case, the molar ratio of the phosphorus to the metal from group VIB is of between 0.1 and 2.5 mol/mol, preferably of between 0.1 and 2.0 mol/mol, and more preferably still of between 0.1 and 1.0 mol/mol or between 0.15 and 0.8 mol/mol, or also between 0.2 and 0.6 mol/mol.

The preferred phosphorus precursor is phosphoric acid H₃PO₄ but its esters and its salts, such as ammonium phosphates, are also suitable, just like polyphosphates. The phosphorus can also be introduced at the same time as the element(s) from group VIB in the form of Keggin, lacunary Keggin, substituted Keggin or Strandberg-type heteropolyanions.

Case of the Organic Additives:

The addition of an organic additive to the hydrotreating catalysts has been recommended by a person skilled in the art in order to improve their activity. They are known to improve the dispersion of metals at the surface of the support and/or to play a beneficial role during the sulfidation of the catalysts. Thus, one or more organic additives well known to a person skilled in the art can advantageously be added at this stage. Generally, the amount of each organic additive added is defined so that the additive/metals molar ratio is of between 0.1 and 1 in the impregnation solution.

The patent FR 3 083 134 describes examples of organic additives which may be suitable and which can be used in aqueous form, and which can thus be added to the impregnation solution (in stage (e) or stage (f)). The patent FR 3 083 131 also describes examples of organic additives which may be suitable but which will instead be added separately, in preimpregnation or in postimpregnation of the support.

Case of the Organic Compounds for Extraction of the Metals:

The metal solution resulting from stage (b), (c) or (d) can contain an excess of organic compound, with respect to the desired impregnation solution. The ratios of organic compound to metals can be adjusted in two ways. The first way consists in adding a concentrated solution of metal precursors or in directly dissolving these metal precursors, in order to achieve the desired ratios. In this case, the final catalyst obtained will comprise a mixture of recycled metals and new metals.

If the excess of organic compound is too high to use the first way (i.e., the amount of recycled metals incorporated in the final catalyst is not significant, for example less than 5% of the total amount of metals), the second way then consists in removing, from the metal solution, all or part of the excess organic compound. In this case, the organic compound can be recycled to stage (b). For this, any method known to a person skilled in the art for separating an organic molecule from a metal solution is envisaged.

Stage (f): Impregnation

According to stage (f), a porous support, or a catalyst already containing one or more metals (according to the definition of “support” given above), is brought into contact with the solution obtained in stage (b), (c), (d) or (e). According to stage (f), the operation in which said porous support or said catalyst is brought into contact with the metal salt in solution can be carried out by any known method, such as, for example, ion exchange, dry impregnation, excess impregnation, vapor phase deposition, and the like. The contacting operation can take place in one stage or in several successive stages.

According to a preferred mode, stage (f) of bringing said support into contact with the metal solution is carried out by excess impregnation or by dry impregnation.

Equilibrium or excess impregnation consists in immersing the support or the catalyst in a volume of solution (often considerably) greater than the pore volume of the support or of the catalyst. Dry impregnation consists, for its part, in introducing a volume of impregnation solution equal to or slightly less than the pore volume of the support or of the catalyst. Dry impregnation makes it possible to deposit, on a given support or a given catalyst, all of the constituents of the impregnation solution.

Stage (f) can advantageously be carried out by one or more excess impregnations of solution or preferably by one or more dry impregnation(s), and, for example, by a single excess impregnation, using the impregnation solution.

Stage (f) is carried out at a temperature generally of between 10° C. and 95° C., at a pressure of between atmospheric pressure and 20 bar, preferably at atmospheric pressure, and for a period of time preferentially between 1 minute and 20 hours, preferably of between 1 and 300 minutes. Stage (f) is preferably carried out at a temperature of between 10° C. and 60° C., preferably at ambient temperature.

Advantageously, after each impregnation stage, the impregnated support or catalyst is left to mature. Maturation makes it possible for the impregnation solution to disperse homogeneously within the support or the catalyst.

Any maturation stage described in the present invention is advantageously carried out at atmospheric pressure, in a water-saturated atmosphere and at a temperature of between 17° C. and 50° C., and preferably at ambient temperature. Generally, a maturation time of between ten minutes and forty-eight hours and preferably of between thirty minutes and six hours is sufficient.

Advantageously, stage (f) is followed by a stage of drying at a temperature of less than 200° C., preferably of between 50 and 180° C., more preferentially between 70 and 150° C. and very preferably between 75 and 130° C. The drying stage is preferentially carried out for a period of time of between 10 minutes and 24 hours. Longer periods of time are not ruled out but do not necessarily contribute an improvement. The drying stage can be carried out by any known technique. It is advantageously carried out at atmospheric pressure or at reduced pressure. Preferably, this stage is carried out at atmospheric pressure. It is advantageously carried out using hot air or any other hot gas. Preferably, the gas used is either air or an inert gas, such as argon or nitrogen. Very preferably, the drying is carried out in the presence of nitrogen and/or of air and is advantageously carried out in a traversed bed.

According to an alternative form, the drying is advantageously carried out so as to preferably retain at least 30% by weight of the organic additive introduced during stage (e) and/or stage (f). Preferably this amount is greater than 50% by weight and more preferably still greater than 70% by weight, calculated on the basis of the carbon remaining on the catalyst.

According to an alternative form, the drying is advantageously carried out so as to preferably retain at least 30% by weight of the organic extraction compound introduced during a stage (f); preferably, this amount is greater than 50% by weight and more preferably still greater than 70% by weight, calculated on the basis of the carbon remaining on the catalyst.

Optionally, the drying can be followed by a calcination stage. This can be the case, for example, if it is desired to remove all or part of one or more organic extraction compounds. According to this alternative form, on conclusion of the drying stage, a calcination stage is carried out at a temperature of between 200° C. and 600° C., preferably of between 250° C. and 550° C., under an inert atmosphere (for example nitrogen) or under an atmosphere containing oxygen (for example air). The duration of this heat treatment is generally of between 0.5 hour and 16 hours, preferably between 1 hour and 5 hours. After this treatment, the active phase is thus found generally in the oxide form; the heteropolyanions are thus converted into oxides. Likewise, the catalyst no longer contains or contains very little organic extraction compound and organic additive. However, the introduction of the organic additive during its preparation has made it possible to increase the dispersion of the active phase, thus leading to a more active catalyst.

Preferably, the catalyst is not subjected to a calcination.

In the embodiment in which stage (f) is carried out via at least two impregnation cycles, each impregnation is advantageously followed by a drying and optionally by a calcination.

The oxide support employed in stage (f) of the process according to the invention is usually a porous solid chosen from the group consisting of: aluminas, silica, silica-aluminas and also titanium or magnesium oxides, used alone or as a mixture with alumina or silica-alumina.

The oxide support advantageously exhibits a total pore volume of between 0.1 and 1.5 ml/g, preferably between 0.4 and 1.1 ml/g.

The specific surface of the oxide support is advantageously of between 5 and 400 m²·g⁻¹, preferably between 10 and 350 m²·g⁻¹, more preferably between 40 and 350 m²·g⁻¹. The specific surface is determined in the present invention by the BET method according to the standard ASTM D3663.

The oxide support of the recycled catalyst according to the invention can be of the same nature as the support of the source catalyst, a description of which has already been given above.

It is preferably chosen from the group consisting of: silica, the family of the transition aluminas and the silica-aluminas. Very preferably, the oxide support is essentially constituted by at least one transition alumina, that is to say that it comprises at least 51% by weight, preferably at least 60% by weight, very preferably at least 80% by weight, indeed even at least 90% by weight, of transition alumina. It preferably consists solely of a transition alumina. Preferably, the oxide support of said catalyst of the process according to the invention is a γ-phase alumina.

In another preferred case, the oxide present in the support of said catalyst of the process according to the invention is a silica-alumina containing at least 50% by weight of alumina, with respect to the total weight of the composite support. The silica content in the support is at most 50% by weight, with respect to the total weight of the support, generally less than or equal to 45% by weight, preferably less than or equal to 40%.

Sources of silicon are well known. Mention may be made, by way of example, of silicic acid, silica in the powder form or in the colloidal form (silica sol), or tetraethyl orthosilicate Si(OEt)₄.

When the support for said catalyst is based on silica, it contains more than 50% by weight of silica, with respect to the total weight of the support, and, generally, it contains only silica.

According to a particularly preferred alternative form, the support consists of alumina, silica or silica-alumina.

The oxide support can also advantageously additionally contain from 0.1% to 80% by weight, preferably from 0.1% to 50% by weight, of zeolite, with respect to the total weight of the support. In this case, any source of zeolite and any associated preparation method known to a person skilled in the art can be incorporated. Preferably, the zeolite is chosen from the group FAU, BEA, ISV, IWR, IWW, MEI, UWY and preferably the zeolite is chosen from the group FAU and BEA, such as zeolite Y and/or beta zeolite, and particularly preferably such as USY and/or beta zeolite.

The support can also contain at least a part of the metal(s) VIB and VIII and/or at least a part of the phosphorus and/or at least a part of the sulfur and/or at least a part of the organic additive(s), apart from those which can be introduced during stage (e) and/or stage (f). They are introduced, for example, during the preparation of the support. This is then referred to as a “preimpregnated” support.

It is also possible to add one or more metals to the support already impregnated with the impregnation solution according to the invention. This is then referred to as a “postimpregnated” support.

In both cases, “preimpregnated” or “postimpregnated” support, the aim is the same: it is a question of adjusting the metal content of the final catalyst, either by adding a certain amount of the metal(s) present in the impregnation solution according to the invention or by adding one or more other metals in a separate stage, with another impregnation solution in particular, before and/or after the stage (f) of impregnation with the impregnation solution of the invention.

The support can even be a catalyst, which will thus be further “charged” with metals. It can be a catalyst which has been depleted in metals, and in particular be a spent catalyst itself, optionally regenerated and then optionally rejuvenated.

The support is advantageously provided in the form of beads, extrudates, pellets or irregular and nonspherical agglomerates, the specific shape of which can result from a crushing stage.

The active phase of the recycled catalyst targeted by the process according to the invention is generally of the type of that already described above for the “spent” catalyst. It is also possible to seek to produce a recycled catalyst according to the invention containing a lower charge of metals than the spent catalyst used, in particular if this makes it possible not to concentrate the solution of extracts before impregnation. The recycled catalyst can then be used differently (on different hydrocarbon feedstocks) from the spent catalyst from which it is derived (for example a catalyst having 20% weight of Mo expressed as MoO₃, with respect to the weight of the dry catalyst, can be used for the hydrotreating of distillates, whereas a catalyst containing a lower charge of Mo, 10% by weight of Mo expressed as MoO₃, can be used for the hydrotreating of naphtha).

The amount of recycled metals contained in the catalyst according to the invention is of between 1% and 100% by weight of the metals contained in the catalyst produced according to the invention, preferably between 10% and 100% by weight, in a preferred way between 20% and 100% by weight and more preferably still between 50% and 100% by weight of the metals contained in the catalyst according to the invention.

It should be emphasized that the catalyst produced according to the invention can have a different formulation from the spent catalyst used to recover the metals and different amounts of metal and different ratios between metals: thus, as said above, a spent catalyst comprising a high charge of metals can, according to the invention, be used to produce a catalyst comprising a lower charge of metals (or vice versa). This makes it possible, if appropriate, to avoid a stage of concentration of the solution after extraction at the end of stage (b) or at the very least to reduce the intensity/duration thereof.

It should also be noted that the catalyst produced according to the invention can be postadditivated, that is to say that it is possible to carry out a stage of additional impregnation with one or more organic additives, the function of which is to increase the catalytic activity with respect to the non-additivated catalysts, before the final sulfidation of stage (g), it being understood that, preferably, a calcination stage is not carried out after its introduction.

Stage (g) (Optional): Sulfidation

Before its use, the catalyst produced by the process according to the invention can undergo an optional sulfidation stage. The sulfidation is preferably carried out in a sulforeducing medium, that is to say in the presence of H₂S and hydrogen, in order to transform metal oxides into sulfides, such as, for example, MoS₂ and Co₉S₈. The sulfidation is carried out by injecting, onto the catalyst, a stream containing H₂S and hydrogen, or else a sulfur compound capable of decomposing to give H₂S in the presence of the catalyst and of hydrogen. Polysulfides, such as dimethyl disulfide (DMDS), are H₂S precursors commonly used to sulfide catalysts. The sulfur can also originate from the feedstock. The temperature is adjusted in order for H₂S to react with the metal oxides to form metal sulfides. This sulfidation can be carried out in situ or ex situ (inside or outside the reactor) of the reactor of the hydrotreating or hydroconversion process according to the invention at temperatures of between 200 and 600° C. and more preferentially between 300 and 500° C.

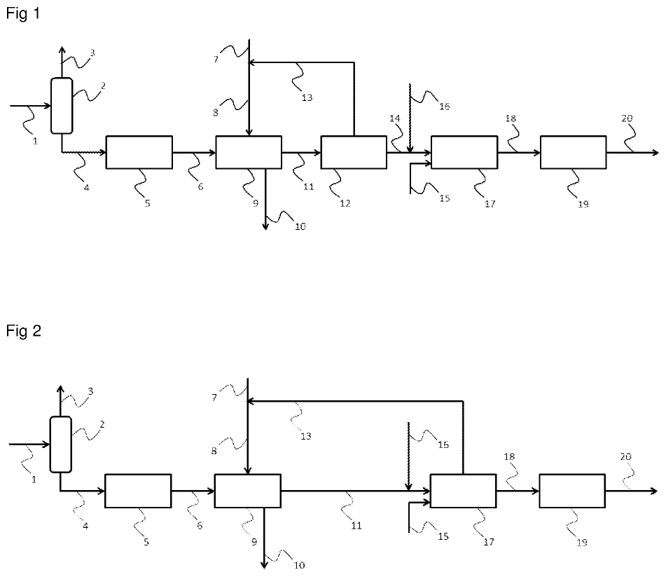

FIG. 1 represents in the form of a block diagram a first alternative form of the process according to the invention:

The source catalyst is sent, via the line 1, to a purification unit 2: optional stage (a1). The effluent containing the contaminants is removed via the line 3 while the purified catalyst is withdrawn via the line 4 and sent to a mill 5: optional stage (a3). The crushed catalyst 6 is sent to an extraction unit 9 in order to recover a metal solution 11 rich in metals: this is the extraction stage (b). For this, an extraction solution 8 comprising an organic compound is used. This extraction solution 8 can be a mixture of recycled extraction solution 13 and of a makeup extraction solution 7 which makes it possible to adjust the ratios and the amounts of the components of the catalyst to be produced, in particular the metals. The extraction unit 9 operates in a temperature range extending from 10 to 150° C., in particular from 10 to 95° C., and a pressure range from 1 to 20 bar.

The unit 9 also generates an effluent 10 containing, inter alia, the source/spent catalyst support and also residual metals. The metal solution 11 is sent to the concentration unit 12; this is the optional concentration stage (d), which makes it possible to obtain a solution 14 with a higher charge of metals. The concentration unit 12 also makes it possible to recover a fraction depleted in metals which is recycled via the line 13 (for example obtained by condensation of the vaporized fraction in the case where the concentration is carried out by evapoconcentration) to constitute a part of the extraction solution 8. A makeup solution 16 which can contain metals, phosphorus and organic additives is added to the solution 14 in order to adjust the composition of the metal solution: this is the adjustment stage (e). The mixture, which constitutes the impregnation solution, and also the catalyst support 15 are subsequently used in the impregnation unit 17 in order to deposit the metals on the support of the catalyst:
this is impregnation stage (f). After the stages well known to a person skilled in the art of optional maturation, of heat treatment and of optional postadditivation, the impregnated catalyst 18 can finally be sent to the sulfidation unit 19 making it possible to transform the metal oxides into their sulfide form: this is the sulfidation stage (g), which is optional (it can also be carried out later, in situ, in the hydrotreating/hydroconversion reactors). The catalyst 20 is finally produced.

FIG. 2 represents in the form of a block diagram a second alternative form of the process according to the invention. It is close to the first alternative form; only the two differences from the first alternative form are indicated below:
the stage (d) of concentration of the solution of metal extracts is deleted,
the outlet solution of the impregnation unit 17 is reused, to constitute a part, in particular the majority or the bulk, of the extraction solution 8.

### Example 1

The starting material is a spent “CoMoP” catalyst, containing molybdenum, cobalt and phosphorus, which are deposited on an alumina support which is used in a hydrotreating process. It was regenerated beforehand under a stream of dry air at 450° C. for 4 hours.

The regenerated catalyst contains molybdenum, phosphorus and cobalt. The composition of the catalyst is expressed in the form of oxides and with respect to the weight of dry catalyst: 21.6% by weight of MoO₃ (14.4% by weight of molybdenum), 3.7% by weight of CoO (2.9% by weight of cobalt, i.e. a Co/Mo molar ratio equal to 0.33) and 3.2% by weight of P₂O₅ (1.4% by weight of phosphorus, i.e. a P/Mo molar ratio equal to 0.3).

A stage of extraction of the metals molybdenum and cobalt from this regenerated catalyst is carried out on the laboratory scale: 40 g of this regenerated catalyst (known as source catalyst), ground beforehand to a particle size of between 100 and 300 microns, and 200 g of extraction solution are introduced into a round-bottomed flask. The extraction solution is an aqueous solution containing 4% by weight of glutaric acid. The pH of the mixture is adjusted to 2.0 by addition of phosphoric acid. The amounts of organic acid (glutaric acid), on the one hand, and of mineral acid (phosphoric acid), on the other hand, were chosen in order not to have to remove/reduce them subsequently in the extract solution which will serve as impregnation solution. The round-bottomed flask, equipped with a reflux condenser in order to limit water losses by evaporation, is subsequently placed in a water bath heated to 85° C. and the mixture is stirred at 200 rpm via a magnetic bar for 6 hours. The mixture is subsequently filtered on a sintered glass of porosity 5, in order to recover a multimetal solution, on the one hand, and a solid residue, on the other hand. The analysis of the solution shows that it contains 25.9 g/l of molybdenum and 4.6 g/l of cobalt. The calculated extraction rates of the Mo and Co are thus 90% and 80% respectively.

The glutaric acid/Mo and Co/Mo ratios of the multimetal solution are adjusted in order to obtain a solution which can be used for the impregnation of a new support.

For this, the multimetal solution is first of all concentrated by evaporation. 80% of the solvent (water) is thus removed in order to obtain 40 ml of solution having 13.0% by weight of molybdenum. The concentrated solution exhibits a glutaric acid/Mo molar ratio of 1.1 compatible with an impregnation solution. The Co/Mo molar ratio is 0.3. The cobalt precursor Co(OH)₂ was thus added in a sufficient amount, i.e. 180 mg, in order to adjust the ratio to 0.4.

Finally, the 40 ml of impregnation solution which are obtained (pH of 1.3) are used to impregnate 10 g of alumina support via an excess impregnation process at ambient temperature for three hours. After 16 hours of maturation at ambient temperature in a humid atmosphere and 2 hours of drying at 120° C., the recycled catalyst obtained has a formulation of 21.1% by weight of MoO₃, 3.6% by weight of CoO and 3.3% by weight of P₂O₅ and contains 100% of recycled Mo.

The catalyst thus produced from recycled metals exhibits a level of performance substantially equivalent to that of a fresh catalyst without recycled metals.

1. A process for the production of a recycled catalyst comprising at least one metal M1 from group VIB, and/or at least one metal M2 from group VIII, optionally phosphorus and/or sulfur, and a support based on oxide(s), characterized in that said process comprises the recycling of at least a part of the metal or metals of a source catalyst comprising the metal M1 and/or the metal M2 common with the recycled catalyst to be produced, the process comprising:
an extraction by an extraction solution of the metal M1 and/or of the metal M2 from said source catalyst, in order to obtain a solution of extracted metal/metals, then—an impregnation of the support with an impregnation solution resulting from said solution of extracted metal/metals, in order to obtain an impregnated substrate, said extracted metal(s) remaining in the liquid phase from the extraction until the impregnation.

2. The process as claimed in claim 1, characterized in that the extraction solution and the impregnation solution have at least one solvent in common.

3. The process as claimed in claim 1, characterized in that the extraction solution and the impregnation solution are acidic media.

4. The process as claimed in claim 1, characterized in that the extraction is carried out with a solution comprising a solvent, in particular an aqueous solvent, and at least one organic compound having complexing properties, and optionally also acidic properties.

5. The process as claimed in claim 1, characterized in that the extraction solution comprises a mineral acid, in particular phosphoric, nitric or boric acid.

6. The process as claimed in claim 1, characterized in that the organic compound comprises one or more chemical functions chosen from a carboxylic acid, phosphonic acid, sulfonic acid, alcohol, thiol, thioether, sulfone, sulfoxide, ether, aldehyde, ketone, ester, carbonate, amine, nitrile, imide, oxime, urea and amide function or also compounds including a furan ring or also sugars.

7. The process as claimed in claim 4, characterized in that the organic compound is chosen from one at least of the following compounds: formic acid, acetic acid, oxalic acid, malonic acid, glutaric acid, glycolic acid, lactic acid, tartronic acid, citric acid, tartaric acid, pyruvic acid, γ-ketovaleric acid, succinic acid, acetoacetic acid, gluconic acid, ascorbic acid, phthalic acid, salicylic acid, maleic acid, malic acid, fumaric acid, acrylic acid, thioglycolic acid, 2-hydroxy-4-methylthiobutanoic acid, glutamic acid, N-acetylglutamic acid, alanine, glycine, cysteine, histidine, aspartic acid, N-acetylaspartic acid, 4-aminobutanoic acid, 1,2-cyclohexanediaminetetraacetic acid, ethylenediaminetetraacetic acid (EDTA), nitrilotriacetic acid (NTA), iminodiacetic acid (IDA), N-(2-hydroxyethyl)ethylenediamine-N,N′,N′-triacetic acid (HEDTA), diethylenetriaminepentaacetic acid (DTPA), bicine, tricine, 1-hydroxyethylidene-1,1-diphosphonic acid (HEDP or etidronic acid), nitrilotris(methylenephosphonic acid), diethylenetriaminepentakis(methylenephosphonic acid), 4-sulfophthalic acid, 3-(N-morpholino)-2-hydroxy-1-propanesulfonic acid (MOPSO), 2-(4-pyridinyl)ethanesulfonic acid, phenol-4-sulfonic acid, thiodiacetic acid and diglycolic acid.

8. The process as claimed in claim 4, characterized in that the organic compound is chosen from one at least of the following compounds: dimethylglyoxime, methyl acetoacetate, ethyl acetoacetate, ethyl lactate, methyl glycolate, ethyl glycolate, dimethyl malate, diethyl malate, dimethyl tartrate, diethyl tartrate, ethyl 3-hydroxybutanoate, ethyl 3-ethoxypropanoate, methyl 3-methoxypropanoate, methyl 3-(methylthio)propanoate, ethyl 3-(methylthio)propanoate, ethylene glycol, diethylene glycol, triethylene glycol, a polyethylene glycol (with a molecular weight of between 200 and 1500 g/mol), propylene glycol, glycerol, 2-butoxyethanol, 2-(2-butoxyethoxy)ethanol, 2-(2-methoxyethoxy)ethanol, triethylene glycol dimethyl ether, a crown ether, acetophenone, 2,4-pentanedione, pentanone, glucose, fructose, sucrose, sorbitol, xylitol, mannitol, γ-valerolactone, propylene carbonate, octylamine, N,N-diethylformamide, N,N-dimethylformamide, N-methylformamide, N,N-dimethylacetamide, propanamide, 1-methyl-2-pyrrolidinone, tetramethylurea, N,N′-dimethylurea, acetonitrile, lactamide, furfurol, 2-furaldehyde, 5-hydroxymethylfurfural, ethyl 3-hydroxybutanoate, 2-hydroxyethyl acrylate, 1-vinyl-2-pyrrolidinone, N,N,N′,N′-tetramethyltartramide, 3-hydroxypropionitrile and N,N′-bis(2-hydroxyethyl)ethylenediamine.

9. The process as claimed in claim 4, characterized in that the concentration of organic compound(s) of the extraction solution is defined so that the organic compound/extracted metal(s) molar ratio, for the organic compound or for each of the organic compound(s), is of between 0.2 and 25, preferably between 0.2 and 11, preferably between 0.2 and 5, preferably between 0.4 and 2 and in a preferred way between 0.4 and 1.2.

10. The process as claimed in claim 1, characterized in that the recycling comprises at least one stage of treatment of the source catalyst, prior to the extraction by the liquid route, chosen from one at least of the following treatments: decoking, separation of compounds of contaminants/impurities type, mechanical grinding.

11. The process as claimed in claim 1, characterized in that the recycling comprises at least one stage of treatment of the solution of extracted metal/metals before impregnation, chosen from at least one of the following treatments: concentration, dilution, modification of the composition of the solution by complete or partial addition or removal of at least one compound.

12. The process as claimed in claim 1, characterized in that the impregnation of the support is carried out starting from the solution of extracted metal/metals and from a makeup of at least one of the metals M1, M2, and optionally of phosphorus and/or of organic additive(s).

13. The process as claimed in claim 1, characterized in that said process comprises:
a sulfidation of the impregnated substrate.

14. The process as claimed in claim 1, characterized in that a part at least of the impregnation solution is reused after impregnation of the support, in particular as makeup for the extraction solution.

15. The process as claimed in claim 1, characterized in that the solution of extracted metal/metals is concentrated in order to withdraw therefrom a part at least of the solvent and optionally a part at least of the optional organic compound(s) which it contains, and in that at least a part of the solvent/of the organic compound(s) thus withdrawn is reused as makeup for the extraction solution.

16. The process as claimed in claim 1, characterized in that it comprises the following stages:
at least one stage (a1, a2, a3) of treatment of the source catalyst,
the extraction (b) with an extraction solution of the metal or metals of said source catalyst, in order to obtain a solution of extracted metal/metals,
at least one optional stage (c) of purification of the solution of extracted metal/metals produced in stage (b) in order to withdraw therefrom all or some of possible impurities,
at least one optional stage (d) of concentration of the solution of extracted metal/metals,
at least one optional stage (e) of adjustment of the composition of the solution of extracted metal/metals resulting from stage (b), (c) or (d),
the impregnation (f) by the liquid route of the support with an impregnation solution resulting from said solution of extracted metal/metals obtained in stage (b), (c), (d) or (e), with an optional makeup of metal/metals, of phosphorus and of organic additive(s), in order to obtain an impregnated substrate, said extracted metal or metals remaining in the liquid phase from the extraction as far as the impregnation,
optional sulfidation (g) of the impregnated support obtained in stage (f).

17. The process as claimed in claim 1, characterized in that the source catalyst is a spent catalyst regenerated or rejuvenated beforehand.

18. The process as claimed in claim 1, characterized in that the support on which the impregnation is carried out with the impregnation solution resulting from the solution of extracted metal/metals is preimpregnated or postimpregnated with an impregnation solution or is a catalyst depleted in metal of the optionally regenerated/rejuvenated spent catalyst type.
